(19) United States
(12) Patent Application Publication
(10) Pub. No.: US 2008/0222522 A1
(43) Pub. Date: Sep. 11, 2008

(54) Method of background form print submission for document enhancement

(75) Inventor: Javier A. Morales, Irondequoit, NY (US)

Correspondence Address: ORTIZ & LOPEZ, PLLC, P. O. BOX 4484, ALBUQUERQUE, NM, 87196-4484, US

(73) Assignee: Xerox Corporation

(21) Appl. No.: 11/714,609

(22) Filed: Mar. 5, 2007

(51) Int. Cl. G06F 17/00; G06F 3/12

(52) U.S. Cl. 715/276; 715/273; 358/1.15; 358/1.1

(57) ABSTRACT

Background form print submission enhancements are provided by attaining background form print submission enhancements for layered documents by generating a background form from a single print job file, the background form containing master data and overlay data in a monolithic page description language (PDL); applying said background form to pages in said document; performing variable length merging on multiple pages of said background form; submitting static content of said document to create said background form; submitting variable content of said document to merge with said background form; and merging arbitrary pages of said background form with said arbitrary pages of a second PDL. The improvement may be best implemented in the print driver while others may be best implemented at the digital front end (DFE) proper. Overall, the improvement aim to retain workflow function with applications that do not actually support true variable information (VI) document authoring.

### TECHNICAL FIELD

Embodiments are generally related to image processing systems and methods. Embodiments are also related to the field of optimizing the production of print jobs. Embodiments are additionally related to background form print submission for achieving document enhancement.

### BACKGROUND OF THE INVENTION

Many processes and devices have been used in the field of printing technology with automated manufacturing systems. In automated manufacturing systems a number of elements are generally used for producing a product from a design. In the field of printing the desired product is a publication such as a book. In printing the design it is typically an electronic version of the publication called a document. In order to get the publication a user specifies the document, the resources to use and how to use the resources. The process of producing the publication can include tasks such as preflight, imposition, watermarking, printing, and joining.

Background forms are meant to enable a simple “mail merge”-type variable information (VI) workflow that does not require explicit application support for variable printing. In general, the overall workflow expects the user to create a complete document with mail merge data. Once the design of the document is finalized, the user is expected to split this document into two documents, one document with static content and another completely separate document with only variable content. The user is then expected to print the static content and make a selection to indicate that this content should be saved for merging at some point in the future. In the case of a printing device such as Xerox Corporation's DocuSP, the static portion of the original document is stored as a Background Form. Electronics for imaging (EFI) controllers store the documents into predefined “Master” documents. The user is then expected to print the mail merge data without any static content and somehow indicate that the previously printed job should be merged with the newly printed mail merge “variable” job.

This workflow has several disadvantages, not the least of which is the fact that the source document can be split into two essentially independent documents. If there is a need for changes, the original document is recreated and split again. This alone creates many needless files and introduces the potential for error. Depending on implementation, sometimes the number of available masters is limited and there's no indication that a given master is currently being used. Both of these problems can further introduce errors by creating the potential for one user to override another user's master. In EFI's implementation, the masters can only be called master1 through master10 and are selected via postscript printer description (PPD) options). Furthermore, some implementations do not provide a mechanism for automatically removing the raster image processed (RiPped) masters (a.k.a Background Forms) once the document has been printed and merged with the stored background form or master.

Based on the foregoing, a need exists for an improved image processing apparatus, methodology and system thereof and in particular, for a series of enhancements to background forms functionality that enable a simpler, less error prone workflow when printing from applications.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for improved image processing systems and methods that can provide improved optimization in document production (e.g., printing).

It is a further aspect of the present invention to provide background form print submission enhancements.

The aforementioned aspects and other objectives and advantages can now be achieved as described herein. A first aspect of the invention provides enhancements to background forms functionality in variable information (VI) printing by enabling a simpler, less error prone workflow than the mail-merge style workflow currently used. The intent is to provide a more robust VI workflow with applications that do not directly support true VI document authoring. Some of the proposed improvements can be best implemented in the print driver while others may be best implemented at the digital front end (DFE) proper.

It is another feature of the present invention that print drivers can be extended (modified) to allow a user to preview pages and mark areas of variable information. The driver would then emit an efficient PDL document with tags for static vs. variable elements, rather than many separate versions of the document as is done with mail-merge applications.

Another aspect of the invention is tailored particularly for printing from applications that support layered content (e.g., InDesign, Quark XPress, etc.). Another idea is to extend the adaptability of print drivers to now be aware of document layers. The driver can allow a user to identify the layers of static and the layers of variable information. The driver can then emit an efficient PDL document with tags for static vs. variable elements.

Enhancements to background forms functionality enables a simpler, less error prone workflow when printing from applications. Specifically, this invention proposes several mechanisms for eliminating the problems common from use of mail-merge style workflows used in the background forms. Overall, these improvements aim to retain this workflow's intent to function with applications that do not actually support true VI document authoring. This method attains the ability for user to directly flag content as static and variable on applications that do not support VI authoring.

The present invention enables the generation of background information from a single print job file that contains both master and overlay data in a monolithic PDL by applying background forms to some, but not all pages in a document; variable length merging on multi-page background forms that are not driven from a VI PDL can also be obtained; and merging arbitrary pages of a background form with arbitrary pages of another PDL with provision of an interactive print preview in the print driver.

In accordance with a method of the present invention, background form print submission enhancements are provided by attaining background form print submission enhancements for layered documents by generating a background form from a single print job file, the background form containing master data and overlay data in a monolithic page description language (PDL); applying said background form to pages in said document; performing variable length merging on multiple pages of said background form; submitting static content of said document to create said background form; submitting variable content of said document to merge with said background form; and merging arbitrary pages of said background form with said arbitrary pages of a second PDL.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a printing system enabling background form print submission enhancements, which can be implemented in accordance with a preferred embodiment;

FIG. 2 illustrates a high-level flow chart of a method of eliminating the need to manually segregate content when printing from an authoring application that supports layered content for background form print submission enhancements for layered documents, which can be implemented in accordance with an alternative embodiment; and

FIG. 3 illustrates a high-level flow chart 300 of an alternative method of eliminating the need to manually segregate content when printing from an authoring application that supports layered content for background form print submission enhancements for layered documents by extending the print driver to provide the user with an interactive UI that can identify variable content objects which can be implemented in accordance with an alternative embodiment.

### DETAILED DESCRIPTION

The particular values and configurations discussed in these non-limiting examples can be varied and are cited merely to illustrate at least one embodiment and are not intended to limit the scope thereof.

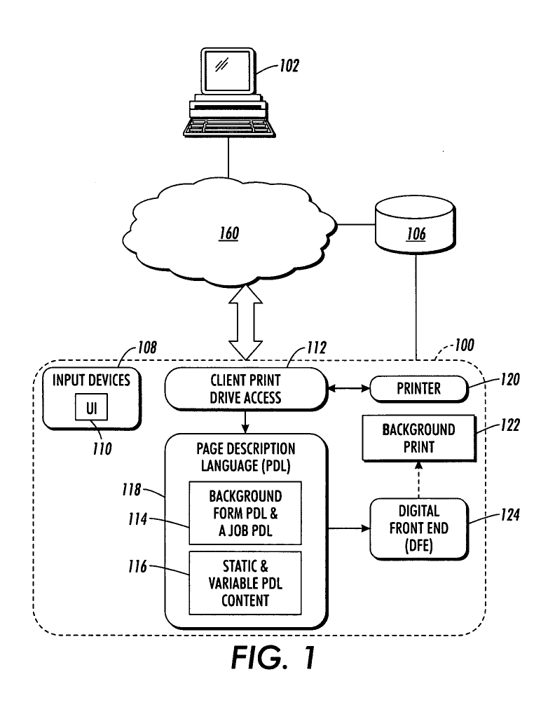

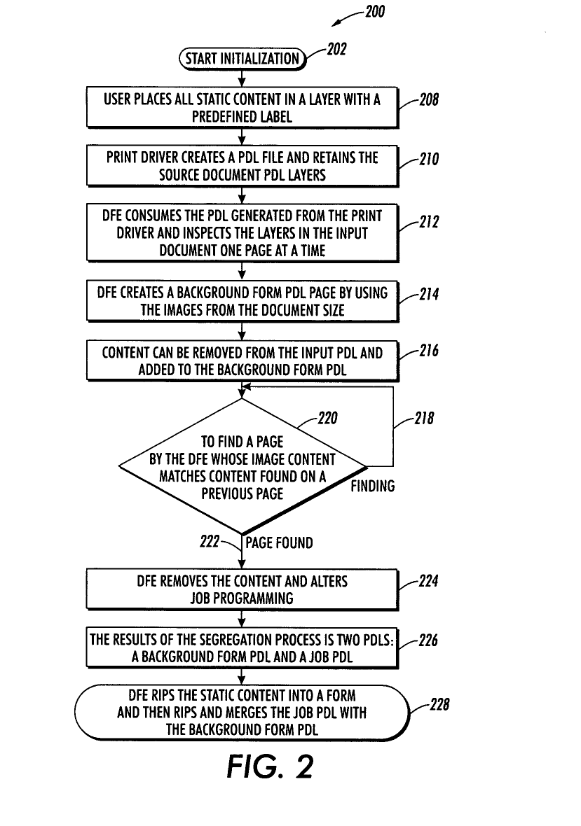

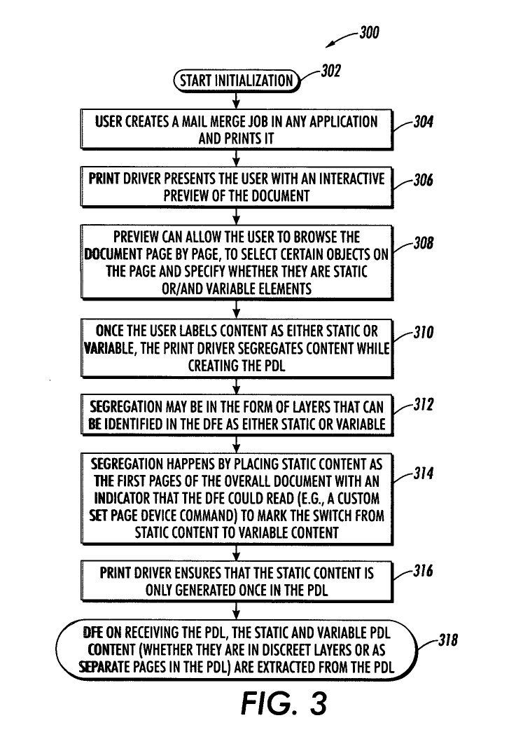

Referring now to the drawings and in particular to FIG. 1, illustrated is a printing system 100 adapted for background form print submission enhancements, which can be implemented in accordance with a preferred embodiment. A printing system 100 includes input devices 108 that comprises of a user interface 110, a digital front end (DFE) 124, and a printer 112 that can process print jobs together with the DFE based on instructions in print drivers accessible from a client as shown in block 112 (client print drive access). The printer driver access from a client can be configured with the page description language (PDL) 118 which can be set with the background form PDL and a job PDL 114 and can also be set with the static and variable PDL content 116. The DFE 124 can include access to background print 122 that assist with page description language (PDL) 118, typically embodied in software such as portable document format (PDF), page description language (PDL), and also modules that enable image processing and control functions such as those described with respect to FIGS. 2 and 3.

A user can access and operate the printing system 100 using the user interface 110 or via a workstation 102. A workstation 102 communicates with a printing system 100 utilizing a communications network 160. A user profile, work product for printing, media library and print job parameters can be stored in a database or memory 106 accessible by the workstation 102 or printing system 100 via the network 160, or can be directly accessed via the printing system 100. It is generally understood that the print driver is generally always in the client and not in a printing system 100. A printing system 100 generally has access to print drivers stored in a client 102 via a connection to the digital front end (DFE) 124 which in turn connects to the print engine 120. FIG. 1 illustrates that the printing system 100 has access to printer driver 112 via block 112, which should be appreciated as generally coming from the client 102.

FIG. 2 illustrates a high-level flow chart 200 of a method of eliminating the need to manually segregate content when printing from an authoring application that supports layered content for background form print submission enhancements for layered documents, which can be implemented in accordance with an alternative embodiment. As indicated at block 202, the process begins. Next, a user places all static content in a layer with a predefined label as depicted at block 208. Thereafter as indicated at block 210, the print driver creates a PDL file and retains the source document PDL layers. Next as depicted at block 212, DFE consumes the PDL generated from the print driver and inspects the layers in the input document one page at a time. DFE creates a background form PDL page by using the images from the document pages as described at block 214. Next, as depicted at block 216, content is removed from the input PDL and added to the background form PDL. Next as described at block 220, a page is found by the DFE whose image content matches content found on a previous page and if the page is not found the finding 216 is repeated again until the page is found 222. Thereafter, as described at block 224, the DFE removes the content and alters job programming. The result of the segregation process is two PDLs: a background form PDL and a job PDL as depicted at block 226. Finally as indicated at block 228, DFE rips the static content into a form and then rips and merges the job PDL with the background form PDL.

The foregoing method is available in any application. The user does not have to change anything to take advantage of this functionality. It would satisfy the “name & address” VI printing that makes up the bulk of what people are doing today. This method also eliminates the need to split the original document into static and variable components that can be kept in sync and builds background form documents with the absolute minimum number of pages available. Hence it allows merging of arbitrary background form document pages with arbitrary variable PDL pages without complex VI authoring which allows the VI document to contain conditional pages without needing VI support.

FIG. 3 illustrates a high-level flow chart 300 of an alternative method of eliminating the need to manually segregate content when printing from an authoring application for background form print submission enhancements by extending the print driver to provide the user with an interactive UI that can identify variable content objects which can be implemented in accordance with an alternative embodiment. As indicated at block 302, the process begins. Next as depicted at block 304, user creates a mail merge job in any application and prints it and then the print driver presents the user with an interactive preview of the document as described at block 310. The preview can allow the user to browse the document page by page to select certain objects on the page and specify whether they are static or variable elements as depicted at block 312. Next as described at block 314, once the user labels content as either static or variable, the print driver segregates content while creating the PDL and this segregation in the form of layers can be identified in the DFE as either static or variable as indicated at block 316. Thereafter as described at block 318, segregation happens by placing static content as the first pages of the overall document with an indicator that the DFE could read (e.g. a custom set page device command) to mark the switch from static content to variable content. The print driver ensures that the static content that is repeated in multiple pages is only generated once in the PDL as depicted at block 320. Finally as indicated at block 322, the DFE on receiving the PDL, the static and variable PDL content (whether they are in discreet layers or as separate pages in the PDL) are extracted from the PDL.

This alternative method is available in any application and it eliminates the limitation on the use of variable images. This alternative method also uses a familiar approach to presenting the information to the user (interactive print preview like those available in Acrobat and MS Word).

Modifications to the system and method can incorporate the use predefined layer positioning (e.g. the utilizing the bottom-most layer) to identify background form content.

Furthermore, the system and method can also be modified to adapt print drivers to enable a user to specify which layers should be background forms and which should be variable content. The system and methods can also be modified such that content types can be utilized to automatically segregated between static and variable content for a document.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of attaining background form print submission enhancements for layered documents processed by a printing device, comprising:
generating a background form from a single print job file, said background form containing master data and overlay data in a monolithic page description language (PDL);
applying said background form to pages in said document;
performing variable length merging on multiple pages of said background form;
submitting static content of said document to create said background form;
submitting variable content of said document to merge with said background form; and
merging arbitrary pages of said background form with said arbitrary pages of a second PDL.

2. The method of claim 1 further comprising:
consuming said background form by a digital front end (DFE) adapted for inspecting layers in an input document at least one page at a time;
creating background form PDL pages with said DFE wherein a plurality of images can be used from a plurality of pages of said document; and
removing a plurality of said contents from input PDL wherein said contents can be added to said background form PDL.

3. The method of claim 3 wherein said DFE finds said page, an image content matches content found on a previous page and said DFE removes said image content.

4. The method of claim 3 wherein said DFE alters job programming wherein affected pages can be merged with previously created pages bearing said background form PDL.

5. The method of claim 1 further comprising:
adapting a print driver to provide a user of the printing device with an interactive UI wherein identification can be done to said variable content objects; and
presenting said user with an interactive preview of said document by said print driver.

6. The method of claim 5 further comprising:
segregating in the form of layers wherein an identification is identified by said DFE as either static with at least one variable of said content;
placing said static content as said first page of the overall said document wherein an indicator is used for said DFE to read; and
marking the switch by said DFE from said static content to said variable content as segregation occurs.

7. The method of claim 5 wherein said DFE receives said PDL content wherein said static and variable PDL content can be extracted from said PDL content and processed.

8. The method of claim 1 wherein said background form including background form content stored in a predefined document layer.

9. The method of claim 1 wherein said step of generating a background form from a single print job file is initiated from instructions associated with print drivers at a client.

10. The method of claim 9 wherein said print drivers adapted to enable a user to specify a layer with background forms and another layer with variable content.

11. The method of claim 1 wherein said step of generating a background form from a single print job file is initiated from instructions associated with print drivers at a client, said print drivers adapted to enable a user to specify a first layer with static content and a second layer with variable content.

12. A method of attaining background form print submission enhancements for layered documents comprising:
generating a background form from a single print job file, said background form containing master data and overlay data in a monolithic page description language (PDL), said background form including background form content stored in a predefined document layer;
applying said background form to pages in said document;
performing variable length merging on multiple pages of said background form;
submitting static content of said document to create said background form;
submitting variable content of said document to merge with said background form; and
merging arbitrary pages of said background form with said arbitrary pages of a second PDL.

13. The method of claim 1 wherein said background form including background form content stored in a predefined document layer.

14. The method of claim 1 wherein said step of generating a background form from a single print job file is initiated from instructions associated with print drivers at a client.

15. The method of claim 9 wherein said print drivers adapted to enable a user to specify a layer with background forms and another layer with variable content.

16. The method of claim 1 wherein said step of generating a background form from a single print job file is initiated from instructions associated with print drivers at a client, said print drivers adapted to enable a user to specify a first layer with static content and a second layer with variable content.

17. A system of attaining background form print submission enhancements for layered documents comprising:
a digital front end (DFE) adapted for processing variable information documents using background form data;
access to printer drivers associated with a client, wherein said printer drivers are accessible by the DFE to enable a user to preview pages, manage background form data and modify variable information documents; and
a plurality of input devices that can be tied in with the user interface to enable said user to preview variable information documents and modify areas of said variable information documents using background form data.

18. The system of claim 17 wherein said print drivers are adapted to enable a user to specify at the DFE a layer with background forms and another layer with variable content.
